(19) United States
(12) Patent Application Publication
(10) Pub. No.: US 2025/0141175 A1
(43) Pub. Date: May 1, 2025

(54) L++ BAND AMPLIFIER

(71) Applicant: II-VI Delaware, Inc., Wilmington, DE (US)

(72) Inventors: Ian Peter McClean, Wilmington, DE (US); Nadhum Kadhum Zayer, Wilmington, DE (US)

(21) Appl. No.: 18/384,071

(22) Filed: Oct. 26, 2023

(51) Int. Cl. H01S 3/23; H01S 3/067; H01S 3/094; H01S 3/16; H01S 3/30

(52) U.S. Cl. CPC H01S 3/2316; H01S 3/06716; H01S 3/094003; H01S 3/1608; H01S 3/302; H01S 2301/02; H01S 2302/00; H01S 2303/00

(57) ABSTRACT

Embodiments of the present disclosure may comprise an optical amplifier system, the system comprising an erbium-doped fiber amplifier. Embodiments may also comprise a C-band amplified spontaneous emission stage configured to generate C-band light. Embodiments may also comprise an L-band stage configured to generate L-Band light. Embodiments may also comprise a Raman amplifier comprising a fiber span. In accordance with various embodiments, the Raman amplifier may be pumped using a portion of the generated C-band light.

### TECHNICAL FIELD

The present disclosure generally relates to an L++ band amplifier.

### BACKGROUND

Aspects of the present disclosure relate to an L++ band amplifier. Various issues may exist with conventional solutions for L++ band amplifiers. In this regard, conventional systems and methods for an L++ band amplifier may be costly, cumbersome, and/or inefficient.

Limitations and disadvantages of conventional systems and methods will become apparent to one of skill in the art, through comparison of such approaches with some aspects of the present methods and systems set forth in the remainder of this disclosure with reference to the drawings.

### BRIEF SUMMARY OF THE DISCLOSURE

Shown in and/or described in connection with at least one of the figures, and set forth more completely in the claims, is an L++ band amplifier.

These and other advantages, aspects and novel features of the present disclosure, as well as details of illustrated embodiments thereof, will be more fully understood from the following description and drawings.

### BRIEF DESCRIPTION OF THE DRAWINGS

The various features and advantages of the present disclosure may be more readily understood with reference to the following detailed description taken in conjunction with the accompanying drawings, wherein like reference numerals designate like structural elements.

FIG. 1 is a block diagram illustrating an optical amplifier system, according to some embodiments of the present disclosure.

FIG. 2 illustrates an exemplary hybrid optical amplifier comprising a Raman amplifier comprising an optical fiber span, and an EDFA comprising a C-band stage and an L-band stage.

FIG. 3 shows illustrative gain v. wavelength plots.

FIG. 4 illustrates an optical hybrid amplifier comprising gain flattening filters.

FIG. 5 illustrates an optical hybrid amplifier comprising a pump amplifier.

FIG. 6 illustrates an optical hybrid amplifier comprising a channel filter.

FIG. 7 illustrates an optical hybrid amplifier similar to that in FIG. 2, using a forward pump structure.

FIG. 8 illustrates an optical hybrid amplifier similar to that in FIG. 7, using a forward-backward pump structure.

FIG. 9 illustrates an optical hybrid amplifier similar to that of FIG. 2, comprising a distributed Raman amplifier and a discrete Raman amplifier.

FIG. 10 illustrates an optical hybrid amplifier similar to that of FIG. 9 with a supplementary Raman pump unit (RPU) 150.

FIG. 11 illustrates an optical hybrid amplifier comprising higher order pumping.

### DETAILED DESCRIPTION

The following discussion provides various examples of method and system for an L++ band amplifier. Such examples are non-limiting, and the scope of the appended claims should not be limited to the particular examples disclosed. In the following discussion, the terms “example” and “e.g.,” are non-limiting.

The figures illustrate the general manner of construction, and descriptions and details of well-known features and techniques may be omitted to avoid unnecessarily obscuring the present disclosure. In addition, elements in the drawing figures are not necessarily drawn to scale. For example, the dimensions of some of the elements in the figures may be exaggerated relative to other elements to help improve understanding of the examples discussed in the present disclosure. The same reference numerals in different figures denote the same elements.

The term “and/or” means any one or more of the items in the list joined by “and/or”. As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y and/or z” means “one or more of x, y and z”.

The terms “comprises,” “comprising,” “comprises,” and/or “including,” are “open ended” terms and specify the presence of stated features, but do not preclude the presence or addition of one or more other features.

The terms “first,” “second,” etc. may be used herein to describe various elements, and these elements should not be limited by these terms. These terms are only used to distinguish one element from another. Thus, for example, a first element discussed in this disclosure could be termed a second element without departing from the teachings of the present disclosure.

Unless specified otherwise, the term “coupled” may be used to describe two elements directly contacting each other or describe two elements indirectly connected by one or more other elements. For example, if element A is coupled to element B, then element A can be directly contacting element B or indirectly connected to element B by an intervening element C. Similarly, the terms “over” or “on” may be used to describe two elements directly contacting each other or describe two elements indirectly connected by one or more other elements.

Embodiments of the present disclosure may comprise an optical amplifier system, the system comprising an erbium-doped fiber amplifier comprising a C-band amplified spontaneous emission stage configured to generate C-band light and an L-band stage configured to generate L-Band light. The optical amplifier further comprises a Raman amplifier comprising a fiber span. In accordance with various embodiments, the Raman amplifier may be pumped using a portion of the generated C-band light.

In accordance with various embodiments, the system may comprise a pump amplifier that amplifies the portion of the generated C-band light. In accordance with various embodiments, the system may comprise a channel filter that filters the light used to pump the Raman amplifier. In accordance with various embodiments, the Raman amplifier may be configured to provide its highest gain in the L++ band.

In accordance with various embodiments, the Raman amplifier may be configured to generate a complimentary gain to the gain of the erbium-doped fiber amplifier, such that a combined gain in the optical amplifier system may be substantially flat in the C-band, the L-band and the L++-band. In accordance with various embodiments, the system may comprise one or more gain flattening filters.

In accordance with various embodiments, the one or more gain flattening filters may be configured to shape the gain of the Raman amplifier and/or may be configured to shape a combined gain of the erbium-doped fiber amplifier and the Raman amplifier. In accordance with various embodiments, the Raman amplifier may be a Distributed Raman amplifier. In accordance with various embodiments, the system may comprise a Discrete Raman amplifier fiber span. In accordance with various embodiments, the system may comprise a Raman pump unit.

This patent disclosure relates to an optical amplifier, specifically to an optical amplifier suitable to work for an L++ band amplifier. In recent years, communication systems have steadily used larger bandwidths. In optical communications, over the last 20 years or so, transmission bandwidths may have increased to about 4.5 THz for each band. Increasingly now, transmission bandwidths may be increased to even 6 THz and beyond. Often, the bandwidths involved may be termed C-band, approximately for wavelengths from about 1520 nm to about 1575 nm, L-band for bandwidths approximately corresponding to wavelengths from 1575 nm to about 1616 nm, and L++ band for bandwidths extending from approximately 1616 nm to 1626 nm or greater.

Many conventional L-band amplifiers may use erbium-doped fiber amplifiers (EDFAs). However, the gain of conventional erbium-doped fiber amplifiers may quickly reduce beyond 1616 nm. Physical constraints, such as reduced emission profile or increasing excited state absorption, may limit gain and may be hard to overcome.

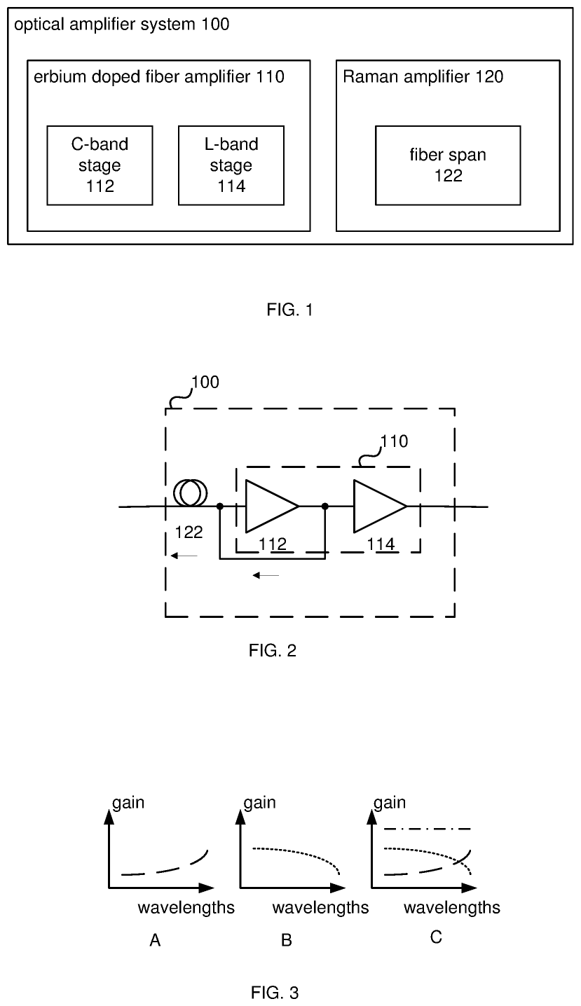

FIG. 1 is a block diagram that describes an optical amplifier system 100, according to some embodiments of the present disclosure. In some embodiments, the optical amplifier system 100 may include an erbium-doped fiber amplifier (EDFA) 110 and a Raman amplifier 120. The EDFA 110 may include a C-band 112 amplified spontaneous emission (ASE) stage configured to generate C-band light and an L-band stage 114 configured to generate L-Band light. The Raman amplifier 120 may include a fiber span 122. The Raman amplifier 120 may be pumped using a portion of the generated C-band light.

The EDFA 110 may be an amplifier using an optical fiber comprising erbium ions, referred to as erbium-doped material. Erbium (Er) may be a rare earth element that may possess special optical properties, particularly in the ability to absorb and emit light in the infrared wavelength range. This property makes erbium-doped materials useful in a variety of optical applications, including erbium-doped fiber amplifiers.

During the fabrication of an optical fiber, small amounts of erbium ions may be intentionally introduced into the core of the fiber. This may be referred to as erbium doping. When these ions in the fiber are excited with external light sources (pump light, often around 980 nm or 1480 nm) and an input signal light is injected into the fiber, the excited erbium ions may release energy in the form of additional photons that may be in phase and coherent with the input optical signal light, thereby effectively amplifying the input signal without the need for electrical to optical conversion. In accordance with various embodiments of the invention, the EDFA may comprise multiple amplifier stages operable in distinct operating bands, namely a C-band stage 112 and an L-band stage 114.

The Raman amplifier 120 may be another type of optical amplifier used in fiber-optic communication systems to amplify optical signals. Unlike erbium-doped fiber amplifiers (EDFAs), which rely on the properties of erbium-doped materials, Raman amplifiers may exploit the Raman scattering phenomenon to achieve signal amplification.

Raman scattering may be a nonlinear optical process where light may interact with the vibrational modes of the material through which it is traveling. When a pump laser is launched into an optical fiber, it may create vibrational modes within the fiber material. These modes may interact with incident signal light, causing energy transfer from the pump light to the signal light. As a result, the signal light may get amplified through the Raman scattering process. The fiber may be a fiber span 122.

Raman amplifiers may provide amplification in a wide range of wavelengths and exhibit low noise levels, in function of e.g., the pump wavelength, the pump power, the length of the fiber span 122 and the interaction between the pump wavelength and the input signal wavelength.

By combining a Raman amplifier 120 with an EDFA 110, a hybrid optical amplifier system 100 may be created. Such a system may combine the relative advantages of EDFAs and Raman amplifiers. In accordance with various embodiments of the present disclosure, the Raman amplifier 120 may extend the amplification bandwidth in the L++ bandwidths. L++, or extended L-band, may also be referred to as Super-L band in some instances. In other words, a hybrid approach may allow for optimized signal amplification across a broader wavelength range while also benefiting from the noise performance and well-established technology of EDFAs.

FIG. 2 illustrates an exemplary hybrid optical amplifier 100 comprising a Raman amplifier comprising an optical fiber span 122, an EDFA 110 comprising a C-band stage 112 and an L-band stage 114. In accordance with various embodiments of the present disclosure, a first portion of the light generated by the C-band stage 112 may be fed into the L-band stage 114 of the EDFA 110. A second portion of the light generated by the C-band stage 112 may be fed to the optical fiber span 122, where it may act like a pump to generate Raman amplification in the fiber span 122 (indicated by the arrows in FIG. 2). In contrast to conventional systems, such a set up may use the C-band stage 112 of the EDFA 110 as a pump to the Raman amplifier optical fiber span 122, and may thereby avoid the use of a dedicated Raman amplifier pump unit.

FIG. 3 shows illustrative gain v. wavelength plots for A: Raman amplifier 120 (dashed line), B: EDFA 110 (dotted line), C: combined gain of the hybrid amplifier (dash-dot line).

As may be seen from A, the Raman amplifier 120 may be configured to generate an increased gain at larger wavelengths, for example at the L++ band wavelengths of 1616 nm to 1626 nm and larger. As may be seen from B, the EDFA 110 may generate a larger gain at shorter wavelengths. The gain of EDFA 110 may drop in the L++ band wavelengths. As may be seen from C, the combined gain of the Raman amplifier 120 stage and the EDFA 110 stage may be substantially flat over a range of wavelengths, as illustrated by the dash-dot line.

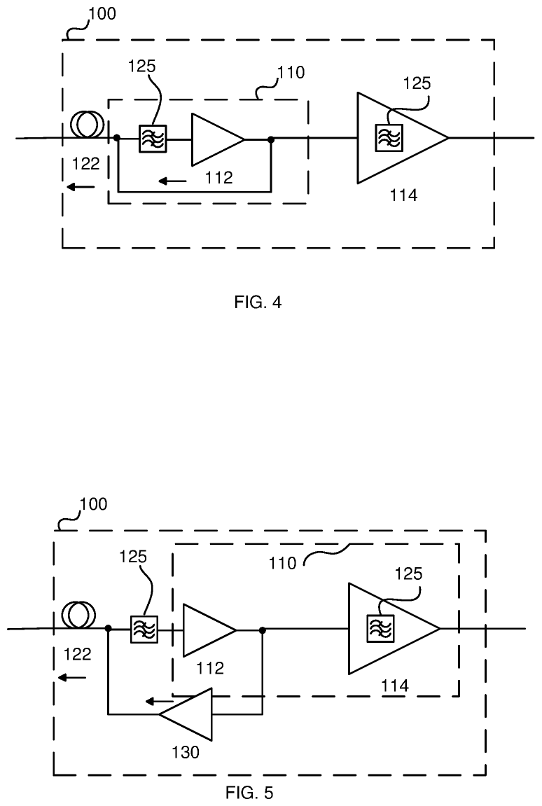

FIG. 4 illustrates an optical hybrid amplifier comprising gain flattening filters 125. A gain flattening filter 125 may be configured to shape advantageously the gain function of the Raman amplifier 120 and/or the EDFA 110. For example, it may be desirable that the Raman 120 gain as shown in FIG. 3, inset A, looks like a vertically flipped version of the EDFA 110 gain as shown in FIG. 3, inset B, so that the combined gain may be flat over a desirable range of wavelengths, FIG. 3, inset C. The gain flattening filters 125 may assist in obtaining a desirable gain v. wavelength shape. A gain flattening filter 125 may be used before the EDFA 110 and/or within the EDFA 110, for example, the L-band stage 114, to flatten a combined gain. Thus, in some embodiments, the one or more gain flattening filter may be configured to shape the gain of the Raman amplifier 120 and/or may be configured to shape a combined gain of the erbium-doped fiber amplifier 110 and the Raman amplifier 120.

FIG. 5 illustrates an optical hybrid amplifier comprising a pump amplifier 130. In some embodiments, the optical amplifier system 100 may include a pump amplifier 130 that amplifies a portion of the generated C-band light. In some instances, it may be desirable to increase the power of the C-band light from the C-band stage 112 used to pump the Raman amplifier 120/fiber length 122 because the properties of the Raman amplifier 120 may, inter alia, depend on the power of the C-band pump light.

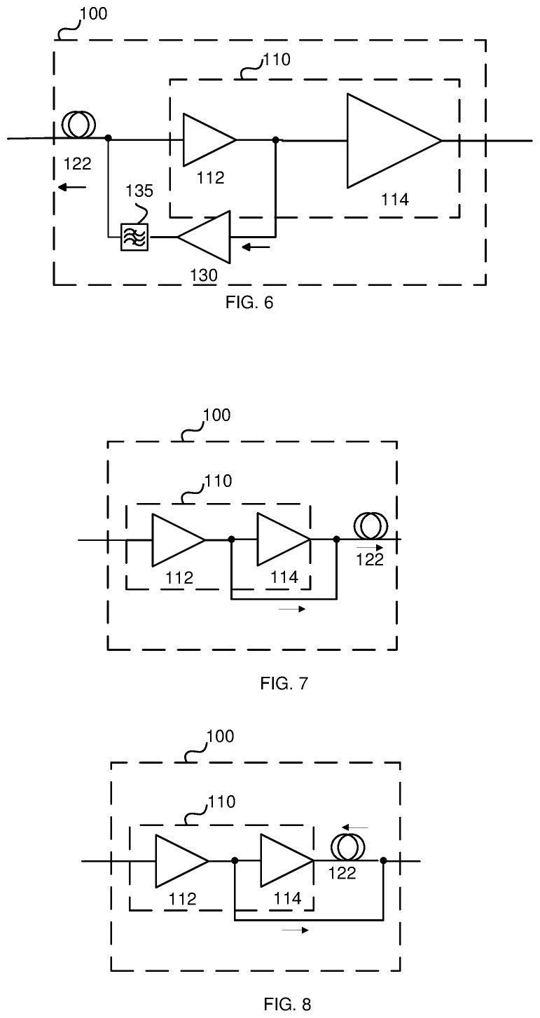

FIG. 6 illustrates an optical hybrid amplifier comprising a channel filter 135. In some embodiments, the optical amplifier system 100 may include a channel filter 135 that filters the light used to pump the Raman amplifier 120/fiber length 122. For example, the C-band light from the C-band stage 112 may be a broadband emission. In such case, it may be preferable to pump selectively the Raman amplifier 120 with one or more narrowband signals to obtain advantageous filter characteristics for the Raman amplifier 120. Thus, in such a case, the channel filter 135 may have one or more narrow passbands, for example.

FIG. 7 illustrates an optical hybrid amplifier similar to that in FIG. 2, using a forward pump. In accordance with various embodiments of the present disclosure, the Raman amplifier 120 may forward pumped with light from the C-band stage 112, as illustrated.

FIG. 8 illustrates an optical hybrid amplifier similar to that in FIG. 7, using a forward-backward pump structure.

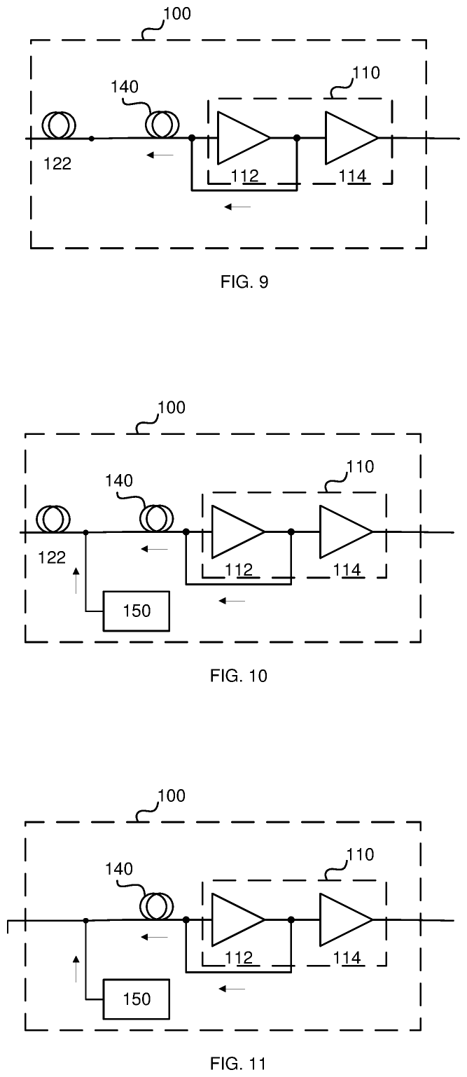

FIG. 9 illustrates an optical hybrid amplifier similar to that of FIG. 2, comprising a distributed Raman amplifier and the discrete Raman amplifier. A discrete Raman amplifier may be one where there is a fiber span dedicated to the Raman amplifier, such as optical fiber span 140. For example, optical fiber span 140 may be part of a localized network equipment. In a distributed Raman amplifier, the fiber span 122 forms part of the communication network. In certain example embodiments, either a discrete Raman amplifier or a distributed Raman amplifier or a combination of both may be used.

FIG. 10 illustrates an optical hybrid amplifier similar to that of FIG. 9. In some instances, it may be advantageous to supplement the pumping from the C-band stage 112 with a Raman pump unit (RPU) 150. This may supply, for example, additional power to a distributed Raman amplifier and/or a discrete Raman amplifier. Accordingly, in some embodiments, the RPU 150 may also be coupled between the optical fiber span 140 and the C-band stage 112 (not shown).

FIG. 11 illustrates an optical hybrid amplifier comprising higher order pumping. In some instances, a cascaded Raman amplification may be desirable. For example, the RPU 150 may generate Raman amplification in optical fiber span 140, which may pump the C-band stage 112. This may increase the power in the C-band stage 112, which in turn may generate Raman amplification together with optical fiber span 140. In accordance with various embodiments, the pumps are often cascaded from a shortest pump wavelength to longer pump wavelengths. For example, the RPU 150 may pump at e.g., 1450 nm, generating a Raman amplification at e.g., 1550 nm, that pumps the C-band stage 112 to generate a stronger signal in the e.g., 1550 nm region. This may be referred to as higher order pumping.

In various example embodiments, channel filters 135, gain flattening filters 125, and/or a pump amplifiers 130 as illustrated in FIG. 4-FIG. 6 may be incorporated into any embodiments as shown in FIG. 1 through FIG. 11. Likewise, any of the embodiments shown in FIG. 1 through FIG. 11 may be implemented using Discrete Raman Amplifiers and/or Distributed Raman amplifiers, as illustrated in FIG. 9. Similarly, any of the embodiments shown in FIG. 1 through FIG. 11 may be implemented with an RPU 150 in addition to the pumping from C-band stage 112. Furthermore, the forward pump structure of FIG. 7 and the forward-backward pump structure of FIG. 8 may be extended to any embodiments shown in FIG. 1 through FIG. 11.

The present disclosure comprises reference to certain examples; however, it will be understood by those skilled in the art that various changes may be made and equivalents may be substituted without departing from the scope of the disclosure. In addition, modifications may be made to the disclosed examples without departing from the scope of the present disclosure. Therefore, it is intended that the present disclosure not be limited to the examples disclosed, but that the disclosure will comprise all examples falling within the scope of the appended claims.

What is claimed is:

1. An optical amplifier system, said system comprising:
an erbium-doped fiber amplifier comprising
a C-band amplified spontaneous emission stage configured to generate C-band light;
an L-band amplifier stage configured to generate L-Band light; and
a Raman amplifier comprising a fiber span, and wherein said Raman amplifier is pumped using a portion of said generated C-band light.

2. The system of claim 1, further comprising a pump amplifier that amplifies said portion of said generated C-band light.

3. The system of claim 1, further comprising a channel filter that filters said light used to pump said Raman amplifier.

4. The system of claim 1, wherein said Raman amplifier is configured to provide its highest gain in the L++ band.

5. The system of claim 1, wherein said Raman amplifier is configured to generate a complimentary gain to the gain of the erbium-doped fiber amplifier, such that a combined gain in said optical amplifier system is substantially flat in the C-band, the L-band and the L++-band.

6. The system of claim 1, further comprising one or more gain flattening filter.

7. The system of claim 6, wherein said one or more gain flattening filter is configured to shape the gain of said Raman amplifier and/or is configured to shape a combined gain of said erbium-doped fiber amplifier and said Raman amplifier.

8. The system of claim 1, wherein said Raman amplifier is a Distributed Raman amplifier.

9. The system of claim 1, further comprising a Discrete Raman amplifier fiber span.

10. The system of claim 1, further comprising a Raman pump unit.

11. The system of claim 10, wherein said Raman pump unit comprises higher order pumping.
